(19) United States
(12) Patent Application Publication
(10) Pub. No.: US 2007/0235100 A1
(43) Pub. Date: Oct. 11, 2007

(54) Double walled, self-insulating, lightweight duct

(75) Inventors: Reg Tomerlin, Los Angeles, CA (US); David S. Larner, Fountain Valley, CA (US); Kathy Jun, Cerritos, CA (US)

Correspondence Address: Vern Schooley;Fulwider Patton Lee & Utecht, LLP, Suite 1550, 200 Oceangate, Long Beach, CA, 90802, US

(73) Assignee: Arrowhead Products Corporation

(21) Appl. No.: 11/248,360

(22) Filed: Oct. 12, 2005

(51) Int. Cl. F16L 11/00; B65H 81/00

(52) U.S. Cl. 138/112; 138/129; 138/148; 156/173; 156/190; 156/195

(57) ABSTRACT

A dual wall duct constructed of heat resistant polymer with a reinforcing cord interposed between the inner and outer tube to form an annulus for entrapment for thermally insulated gas such as air.

### FIELD OF THE INVENTION

The present invention relates to a very lightweight duct for circulating air to or from specified locations within a common carrier.

### BACKGROUND OF THE INVENTION

### Description of the Prior Art

Common carriers such as aircraft, automobiles, naval vessels and trains require the circulation of air and gases within specific areas for controlling the environment and other purposes. To accomplish such circulation, many vehicles use ducts to carry and circulate the gas from one area to another. The use of ducts to circulate gas is commonly known as an environmental control system (“ECS”). Our particular challenging task is the flow of hot air from jet engine bypasses. Using duct systems can be very convenient yet has it own drawbacks.

It has long been recognized that lightweight ducting is desirable for aircraft usage. In recognition of this problem it has proposed to construct dual wall metallic ducting having convolutions spaced along the length of the other tubing. Ducting of this type is shown in U.S. Pat. No. 3,960,343 to Thompson.

At present, construction of most ducts varies from rigid to flexible construction. Most ducts are produced out of flexible metallic material such as aluminum or non-metallic material of various types. To serve their purpose, it is important the ducts used for circulating gases for cooling or controlling the environment maintain the gas near a constant temperature. To achieve thermal insulation of the duct systems, insulation blankets are frequently wrapped around the ducts. The vast majority of insulation blankets are composed of fiberglass, which are covered by polymeric materials that meet high flammability standards.

The problem with the ducts of the present is the weight associated with the insulation blankets. These insulation blankets contribute as much as 15 to 20% of the weight of the ECS duct system. The weight associated with the insulation blankets are undesirable and can be thought of as a parasitic factor in the overall design of the ECS and the common carrier.

Another problem with ducts that use insulation blankets is the time consuming effort of installation. Ducts are typically installed about the time assembly of the common carrier frame is nearing completion. This presents a two-fold problem. The first is that the ducts must be inspected both before and after the insulations are installed. The second problem stems from efforts to conceal the ducts and their structures with the insulation blankets. By covering the ducts, the insulation blankets make it difficult not only to visually inspect ducts, but also to spot any damage or flaws in the ducts. This slows the process for identifying ducts in need of repair or replacement since insulation blankets must be removed and replaced whenever a duct is suspected of being damaged.

Efforts to produce thin wall tubing has focused to a great degree on metallic tubing or the wrapping of thin polyester films. Examples are in U.S. Pat. No. 2,954,803 to Barnes, U.S. Pat. No. 4,299,641 to Kelly and U.S. Pat. No. 6,152,186 to Arney. Metallic tubing suffers the shortcoming that it has a relatively high specific gravity and polyester film does not exhibit the weight, fire and chafe resistance preferable for aerospace applications.

It has been proposed to construct ducts from helically wrapped strips of foam thermoplastic rubber. A device of this type is shown in U.S. Pat. No. 6,729,296. Such ducts, while having utility for general ducting work, suffer the shortcoming that the rubber material does not meet the specifications for aerospace applications and are typically relatively heavy and do not incorporate effective thermal barriers.

In effort to provide thermal barriers, it has been proposed to incorporate thin wall metal foil layers separated by a corrugated thermoplastic resin film. A device of this type is shown in U.S. Pat. No. 3,655,502 to Yoshikawa. Again, devices of this type again add unwanted weight.

Small diameter convoluted polyetherether keytone (ETFE or PEEK) has been proposed for biological applications and for thick walled tubes used for analysis of high pressure gases in chromatography. To applicant's knowledge, it has not been used as the film in large diameter common carrier ducting application or to form thermally insulated air exhausts.

In unrelated areas such as for cryogenic fluid transfer. It has been known to construct dual wall metallic ducts configured with an annulus between a pair of tubes and within which a partial vacuum may be drawn to provide a thermal barrier to heat transfer between the inside and outside of the duct. Such vacuum jacket construction is not generally acceptable for use even in aerospace vehicles as the dual wall metal construction adds significantly to the overall weight and it would be prohibitively expensive to construct the ducting to maintain an effective vacuum and to hold that vacuum. Thus, a need exists in the marketplace for a duct that is lightweight and self-insulating while maintaining flexibility and high flammability standards. Aspects of the present invention fulfils this need.

### SUMMARY OF THE INVENTION

Briefly and in general terms, the present invention is directed to a lightweight thermally insulated duct used for circulating a gas throughout specified areas of a common carrier air. Air is an efficient, lightweight thermal insulator, free of toxins and other recognized drawbacks. The duct of the present invention capitalizes on this expedient by constructing tubular walls to form therebetween an annulus to trap a thermally insulating gas such air. The walls that form the duct are made from polymeric materials. In one preferred embodiment, the material used to form the walls may be a polymide, such as Kapton® or polyetherether ketone film. A film used to form the inner wall of the duct which carries the working fluid may be as thin as 0.0005 inches. A film used to form the outer wall may be as thin as 0.00025 inches. Such thin films trap the gas that helps provide insulation while maintaining a lightweight effect and high temperature flammability standards.

To provide support and shape for the duct, a reinforcing cord may be placed within the two walls that allows for flexibility of movement while maintaining the overall tubular form. In one preferred embodiment, the cord is wound helically about the inner wall. The cord may be of any flexible solid materials that can provide stable shape yet flexibility to the duct. In one preferred embodiment, the cord is hollow and made from a lightweight and high temperature resistant material such as polyethersulfone or polyetherether ketone. Hollow cords such as these provide lesser weight and create better insulation because of their shape and the internal cavities they possess. In another embodiment, the cord may be a solid material such as steel wire. In one preferred embodiment, the cord is attached to the inner wall of the duct by adhesive bonding where the adhesive is highly temperature resistant. Other embodiments may fix the cord between the inner tube and outer tube by using friction.

Various methods are available to trap the insulating gas between the two walls that form the duct. In one preferred embodiment, one or both of the inner and outer walls are shaped by wrapping a film helically about a mandrel to form a tube shape. In another embodiment, a tube is formed by rolling the sheet of the film about itself like a cigarette paper. The outer wall film is bonded to the inner wall by use of a high temperature resistant adhesive. The duct is created by wrapping the outer wall around the inner wall and cord so as to create an annulus structure. When so configured, the reinforcing cord acts as a spacer establishing the thickness of the thermally insulating layer of gas formed between the inner and outer walls.

In one embodiment, a heat shrink tube is shrunk in place about the inner wall and reinforcing cord to trap gas such as air in place.

In order to maximize the efficiency of gas circulation, the duct may also encompass other embodiments that assist in providing thermal insulation and environmental control. In one embodiment, the inner surface of the inner wall may be coated with a thin reflective surface. Such a surface may reflect radiated heat back into a flow stream in such inner tube adding to the efficiency of the construction. Such inner surface may also be formed with a low frictional finish to minimize flow resistance. In another preferred embodiment, the reflective surface is aluminum.

These and other features and advantages of the duct will become apparent from the following detailed description of preferred embodiments which, taken in conjunction with the accompanying drawings, illustrate by way of example the principles of the invention.

### BRIEF DESCRIPTION OF THE DRAWINGS

FIG. 1 is a perspective view of a film being wrapped on a mandrel to form inside tube that may be incorporated in the duct of the present invention;

FIG. 2 is a sectional view, in enlarged scale, taken along the line 2-2 of FIG. 1;

FIG. 3 is a sectional view similar to FIG. 2 with a vapor deposit added;

FIG. 4 is a perspective view similar to FIG. 1 showing a reinforcing cord being wrapped about the inner tube;

FIG. 5 is a perspective view of the inner tube and cord shown in FIG. 5 and showing an outer film wall being wrapped around the exterior to form an outer tube;

FIG. 6 is transverse sectional view, in enlarged scale taken along the lines 6-6 of FIG. 1;

FIG. 7 is a transverse sectional view taken along the lines 7-7 of FIG. 4;

FIG. 8 is a cross sectional view, in enlarged scale, taken along the line 8-8 of FIG. 5;

FIG. 9 is a longitudinal sectional view, in enlarged scale, of the dual wall duct made in FIG. 5;

FIG. 10 is an enlarged detail view taken from the circle 10 shown in FIG. 10;

FIG. 11 is a partial longitudinal sectional view similar to FIG. 10 but of a second embodiment of the duct of the present invention;

FIG. 12 is a perspective view of a shirk tube being extruded on a mandrel to be employed in a third embodiment of the present invention;

FIG. 13 is a longitudinal sectional view, in enlarged scale, of the shrink tube of FIG. 12 telescoped over a reinforced inner tube;

FIG. 14 is a sectional view similar to FIG. 13 but with the outer tube shrunk into place;

FIG. 15 is a longitudinal sectional view of a fourth embodiment of the dual wall duct of the present invention;

FIG. 16 is a detailed view, in enlarged view, taken from the circle designated 16 in FIG. 15;

FIG. 17 is a detailed view similar to FIG. 16 showing a modification thereof; and

FIG. 18 is a longitudinal sectional view, in reduced scale, of the duct shown in FIG. 14.

### DETAILED DESCRIPTION OF THE INVENTION

The lightweight self-insulated duct device of the present invention includes, concentric inner and outer tubes 21 and 23 constructed of flame resistant polymer such as polyetherether keytone. The walls cooperate to form therebetween an annulus 25 housing a helical reinforcing element, generally designated 27, which may also be constructed of a polymer such as polyetherether sulfone and, in the preferred embodiment, serves as a radial spacer for establishing the radial thickness of the annulus 25. In practice, the tubes 21 and 23 are assembled in such a manner as to trap a thermally insulative gas as air in the annulus 25 to cooperate in establishing a thermal barrier to transfer of heat to and from fluid flowing within the interior of the inner tube 21.

Commercial aircraft have typically utilized flexible and rigid ducts of varying diameters and configuration for circulating air within cabin after cooling various components such as electronic racks or for these ducts have often been made of metallic and non metallic materials. For thermal insulation, it is have been common practice to wrap the ducts with fiber glass insulation with a thin film of polymeric material such as to meet the high flammability standard set forth in FAA Regulation FAAR 25.856. These blankets may weigh as much as 15% to 20% of the weight of the entire Environmental Condition System (ECS) ducting. This weight is parasitic and contributes nothing to the structure of the ducting itself. It is the purpose of the present invention to provide a lighter weight efficient ducting construction which will meet the high standards set forth in the industry.

The tubes 21 and 23 may be constructed of various flame resistant polymeric materials which are gas impermeable and of relatively lightweight such as polyetherether keytone sold under the trademark Kapton® or chemically analogous films such as PBI (polybenzimizole). The inner wall 21 will typically have thickness of 0.0004 inches to 0.0010 inches but preferably about 0.0005 inches. To provide some degree of rigidity and reinforcement for the film wall of the inner tube 21 is preferably wound with a reinforcing cord 27 which may be constructed of polyethersulfone and may be constructed with a solid or hollow cross section as the application may demand. In some embodiments the cord possess some degree of springiness and is bonded to the inner tube to, in service, cooperate in maintaining the tube wall descended.

The outer tube 25 is a little thinner than the inner tube, possibly only half the thickness of the inner wall such as, for instance between 0.00020 and 0.00030, and preferably, 0.00025 inches thick. It will be appreciated that with the tubes formed with even a relatively thin annulus 25 of even a relatively thin radial thickness, as for instance 0.100 inches thick, the helically wound reinforcement cord 27 will tend to minimize circulation of the air in the dead space provided by the annulus thus minimizing any tendency of the air in the annulus to provide for dynamic transfer of heat between the inner and outer tubes due to air circulation. To immobilize the reinforcing cord 27 it may be trapped frictionally between the tubes or may be bonded to either the inner or outer tubes 21 or 23 or to both as shown in FIG. 10. One adhesive found effective is NuSil Sil R32-2186 available from NuSil Technology.

As will be appreciated by those skilled in the art the radial thickness of the annulus 25 may be increased by merely increasing the cross sectional of the cord 27 to the diameter for the cord 35 shown in the modification depicted in FIG. 11. The cord may be between about 0.040 and 0.200 inches thick and preferably about 0.100 inches in cross section. In the present example, the cord is shown with a round cross section but, as will be apparent to those skilled in the art, may take many different shapes such as square, oval or rectangular.

In practice, the radially inner surface of the inner tube 21 is coated by a optically reflective coating, such as for example vapor deposited aluminum 31 to a thickness of about 300 angstroms to reflect a major portion of any heat radiated in fluid flowing through the duct and back into the air flow to thus conserve against loss of the corresponding energy. Preferably, this layer of aluminum provides a high polish finish to minimize friction and reduce the resistance to air flow through the duct.

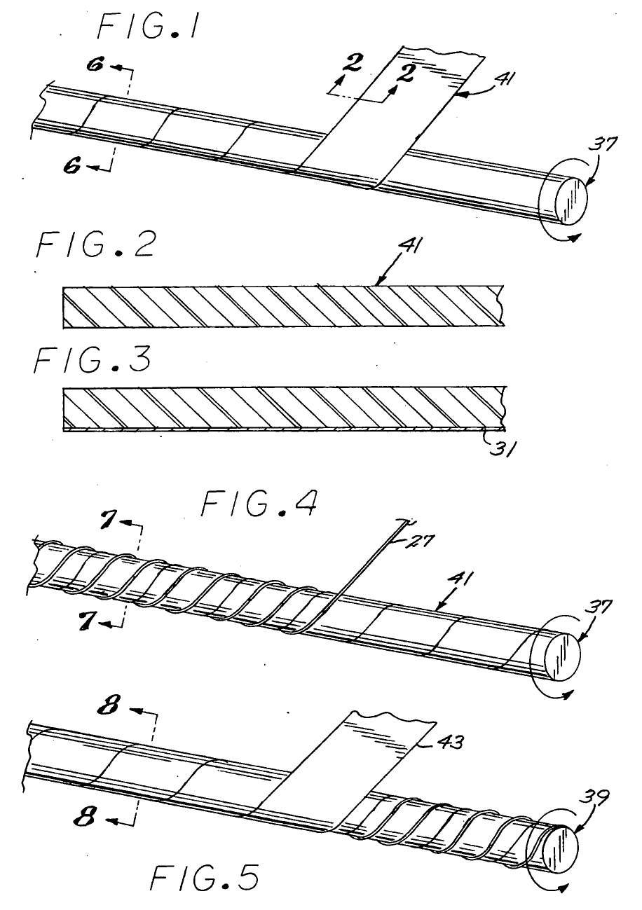

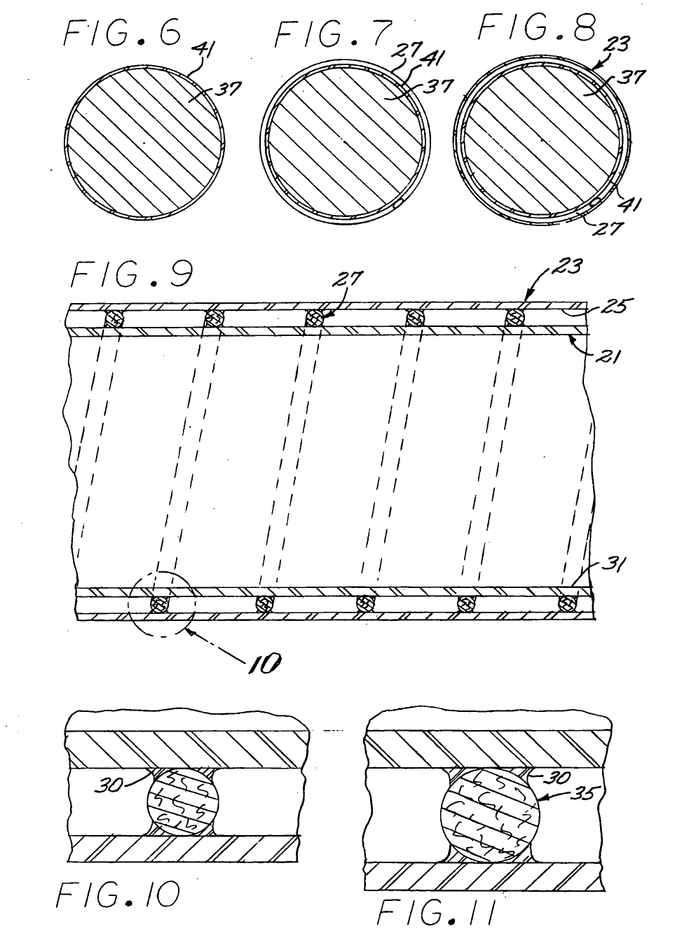

A convenient method of making the tubes 21 and or 23 is to wind a length of thin polyetherether ketone film (PEEK) on a mandrel 37 of the desired diameter as shown in FIG. 1. For gas and air flow applications, it will be appreciated the mandrel may have a diameter on the order of 3″ to 7″ or more, depending on the particular application for the resultant duct. The film strip 41 may be fed onto the mandrel 37 as it is rotated about its own longitudinal axis to wind the strip thereon in a helical pattern to form tube wall as shown in FIG. 6. In one embodiment the opposite edges of film strip 41 are coated with an adhesive and are fed onto the mandrel 37 to cause such edge to overlap to adhere the adjacent helix together. As will be apparent to those skilled in the art the strips may be constructed with self adhering characteristics to bond its helix together and/or bond the cord thereto. In some embodiments, the interior surface of the strip is coated with the 300 angstrom thick vacuum deposited aluminum to create the aluminum surface film 31 (FIG. 3) to afford a smooth low friction and friction reflective surface.

After winding of the film strip 41, with or without the reflective surface 31, the cord 27 may be wound onto the mandrel 37 as shown in FIG. 4 about the helices of the strip 41 with possibly a 2 to 1 pitch. Thereafter, a strip of film 43 0.00025 inches thick, with adhesive under the opposite edges, may be wound about the helices of the cord 27 as shown in FIG. 5 to form the exterior wall 23 as shown in FIGS. 8 and 9. It will be appreciated that during such winding the strip 43 will be operative to trap air or other atmospheric gas in the spaces between the respective helices of the cord 27 at a thickness determined by the diameter of such cord. It will be appreciated that in some embodiments the cord 27 will be held in place by the friction between such cord and the inner and outer tubes 21 and 23. In other embodiments the cord will be coated with adhesive 30 on either or both the inner and outer tangential surfaces such that it will adhere to either the inner tube 21 or the outer tube 23 or both.

Once the adhesive has cured, the dual walled tubing may be extruded from the mandrel 37 and the opposite ends thereof attach to fittings or couplings which will be adaptable for connecting together in any desirable fashion. In some embodiments, one of the other or both of the tubes may be formed with convolutions, either circumferential or helical to thus add to the structural rigidity in the radial direction and afford flexibility to flex off from the longitudinal axis. In the embodiment disclosed one end of the dual wall duct is formed with an end section expanded in diameter to form a bell collar 38 as shown in FIG. 18 to be telescoped over the end of an adjoining member to be bonded in place.

It will be appreciated that the present invention will provide a relatively light weight insulated duct which can be easily formed to different lengths for threading through the passage ways of the various commons carriers such as trains, boats, airplanes and even space vehicles and will pass the most stringent specifications for flammability, smoke emission and toxicity. The product is chafe-resistant and highly damage tolerant possessing such resistance to corrosion as to eliminate the need for coating with oxidation resistant coatings and paints.

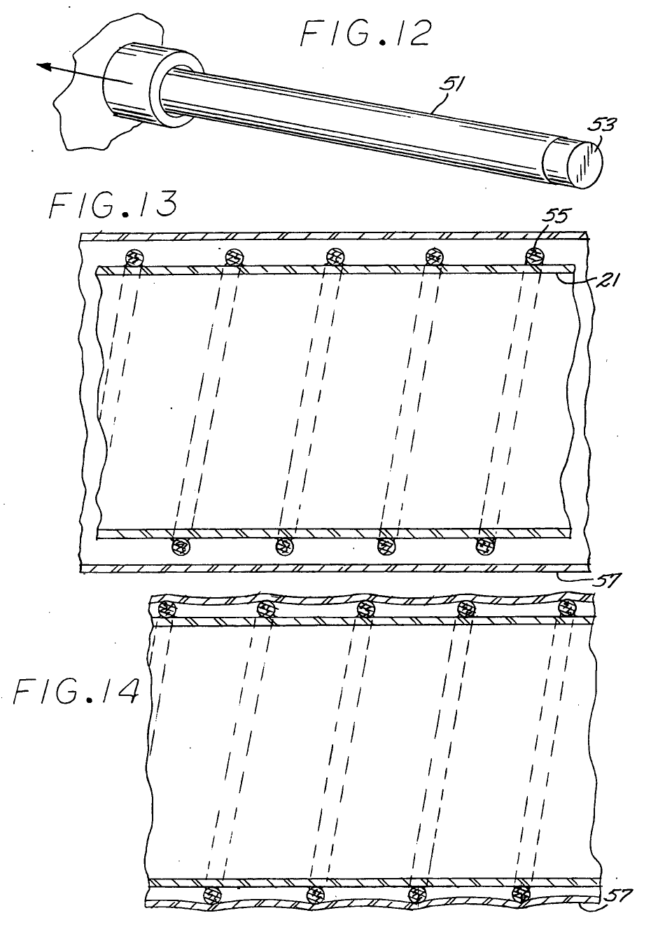

Referring to FIG. 12 in other preferred embodiments the inner and outer or both tubes may be constructed from PEEK tubing 51 extruded on a mandrel 53. It will also be appreciated that in other modifications the film will be provided in blanket form and rolled about a mandrel in cigarette paper fashion to form the desired cross section configuration with the longitudinal seam being sealed by an adhesive.

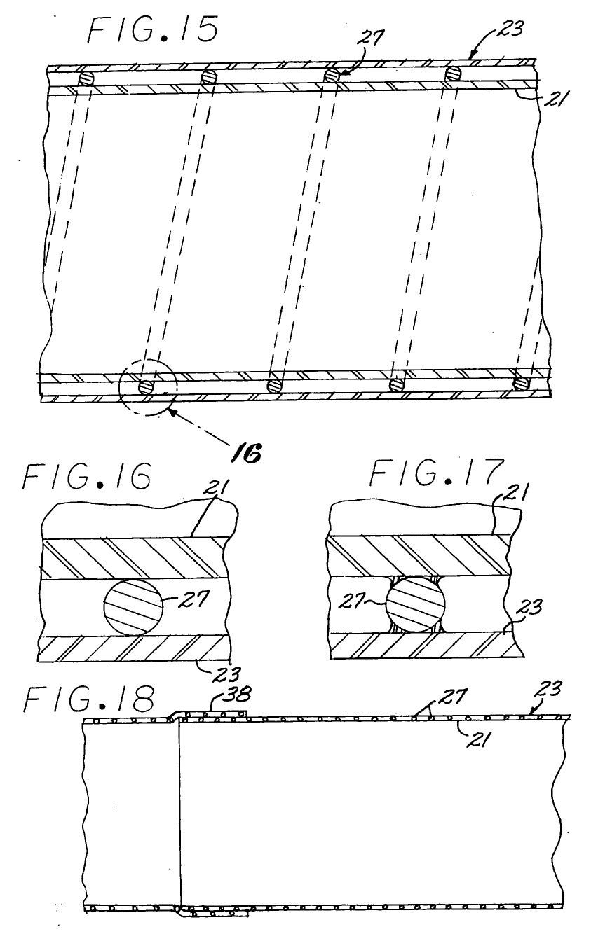

Referring to FIG. 13, in some embodiments the inner tube 21, over wound by a helical cord 55, is telescoped into an oversized tube 57 constructed of a polymer such as PEEK with a memory such that it may be stretched to assume the oversize diameter to be telescoped over the inner tube. The outer tube may then be heated to shrink it radially inwardly into place as shown in FIG. 14 thereby trapping the helices of the cord in position. The outer tube may be selected such that, when shrunk, it compress radially inwardly against the cord to form low pitch convolutions to define smaller radial thickness in the annulus insulation as shown in FIG. 14 to thus frictionally trap the cord in position and minimize the thickness of the annulus between the helices of the cord to thus minimize air circulation therein. In some embodiments of the present invention the inner and outer tubes are constructed from sheets of film to overlap along respective longitudinal seams and the cord 55 trapped therebetween in the annulus as shown in FIGS. 15 and 16. This affords an economical method of forming the duct and, if desirable the cord may be bonded to either the inner or outer tubes or both as shown in FIG. 17.

From the foregoing it will be apparent that a dual wall lightweight self insulating polymer duct of the present invention provides an economical and convenient means for flowing gases such as air through the framework of a common carrier. Particularly, in aircraft which demand greater fuel efficiency, the relatively lightweight of the air insulated polymer provides a particularly useful duct construction.

We claim:

1. An ultra light duct for circulating fluid to a specified location in a common carrier and comprising:
a first flame resistant polymeric film configured to form an inner tube;
a second flame resistant polymeric film configured to form an outer tube surrounding the inner tube and cooperating therewith to form an annulus;
a reinforcing cord wrapped helically about the inner tube and cooperating to form a spacer between the inner and outer tubes and affixed in place; and
a thermally insulating gas trapped in the annulus.

2. The ultra light duct of claim 1 wherein:
at least one of the inner and outer tubes are in the form of a helically wrapped strip of film.

3. The ultra light duct of claim 1 wherein:
the inside surface of the inner tube is coated with an optically reflective material.

4. The ultra light duct of claim 1 wherein:
the inside surface of the inner tube is coated with a low friction material.

5. The ultra light duct of claim 1 wherein:
the outer tube is constructed with a wall thickness of substantially 0.00025 inches.

6. The ultra light duct of claim 1 wherein:
the inner tuber is constructed with a wall thickness of substantially 0.0005 inches.

7. The ultra light duct of claim 1 wherein:
the cord is constructed of polyethersulfone.

8. The ultra light duct of claim 1 wherein:
the gas filling the annulus is air.

9. The ultra light duct of claim 1 wherein:
the outer tube is constructed of helically wound round polyetherether.

10. The ultra light duct of claim 1 wherein:
the outer tube is constructed of polyetherether ketone.

11. The ultra light duct of claim 1 wherein:
the inner and outer tubes are constructed of helically wound polymeric strips.

12. The ultra light duct of claim 1 wherein:
the cord is trapped between the inner and outer tubes by friction.

13. The ultra light duct of claim 1 wherein:
the cord is affixed to at least one of the tubes by adhesive.

14. The ultra light duct of claim 1 wherein:
the inner and outer tubes cooperate to form the annulus having a radial thickness of between 0.040 and 0.200 inches.

15. The ultra light duct of claim 1 wherein:
the outer surface of the inner tube is coated with vapor deposited aluminum having a thickness of substantially 300 angstroms.

16. The ultra light duct of claim 1 wherein:
the outer tube is a heat shrink tube.

17. An ultra light duct comprising:
flame resistant polymeric inner and outer tubes constructed of film an cooperating to form therebetween an annulus;
thermal insulation means in the annulus;
reinforcement means in the annulus and constraining the inner tube against radially outward expansion; and
a thermally insulative gas means in the annulus for insulating against transfer of heat between the inner and outer tubes.

18. A method of constructing an ultra light duct including:
wrapping a first flame resistant, gas impermeable polymeric film around a mandrel to form an inner tube;
wrapping a cord means around the first tube;
adhering the cord to the first tube;
wrapping a second flame resistant, gas impermeable polymeric film around the cord and first tube to form an air tight annulus trapping air therein;
separating the tubes from the mandrel and;
depositing a coat of optically reflective material onto an inner surface of the inner surface of the inner tube.

19. A method of constructing an ultra light duct comprising:
wrapping a first flame resistant, gas impermeable polymeric film around a mandrel;
wrapping a cord around the first polymeric film;
placing a flame resistant, gas impermeable polymeric heat shrink tube around the cord and first polymeric film;
heat shrinking the heat shrink tube around the cord and first polymeric film such that the first polymeric film, cord and heat shrink tube are affixed into place by friction and cooperate to form an annulus;
extruding the duct from the mandrel and;
depositing a coat of optically reflective material onto an inner surface of the inner tube.

20. An ultra light duct for exhausting hot gas from a jet engine bypass and comprising:
a first polyimide film helically wrapped to form an inner tube;
a second polyimide film heat shrunk around the inner tube and cooperating therewith to form an annulus;
a hollow, round, reinforcing cord made of polyethersulfone and wrapped helically about the inner tube and cooperating to form a spacer between the inner and outer tubes and affixed in place; and
a thermally insulating gas trapped in the annulus to, upon flow of the hot gas through the inner tube, insulate against transfer of heat across the annulus.
